(19) United States
(12) Patent Application Publication
(10) Pub. No.: US 2015/0169907 A1
(43) Pub. Date: Jun. 18, 2015

(54) ELECTRONIC TAG, SYSTEM FOR WIRELESSLY CHARGING ELECTRONIC TAG, ELECTRONIC SHELF LABEL SYSTEM, AND METHOD FOR MANAGING POWER OF ELECTRONIC TAG

(71) Applicant: SAMSUNG ELECTRO-MECHANICS CO., LTD., Suwon-Si (KR)

(72) Inventors: Ki Won CHANG, Suwon-Si (KR); Jae Suk SUNG, Suwon-Si (KR); Chang Soo KANG, Suwon-Si (KR); Soon Tack OH, Suwon-Si (KR); Sung Uk LEE, Suwon-Si (KR); Hyun Keun LIM, Suwon-Si (KR); Si Hyung KIM, Suwon-Si (KR); Chul Gyun PARK, Suwon-Si (KR)

(73) Assignee: SAMSUNG ELECTRO-MECHANICS CO., LTD., Suwon-Si (KR)

(21) Appl. No.: 14/271,837

(22) Filed: May 7, 2014

(30) Foreign Application Priority Data
Dec. 13, 2013 (KR) 10-2013-0155686

(51) Int. Cl. G06K 7/10; H02J 7/00; H02J 5/00; H02J 7/02

(52) U.S. Cl. CPC G06K 7/10009; H02J 7/025; H02J 7/007; H02J 5/005; H02J 7/0047; H02J 2007/0096

(57) ABSTRACT

An electronic tag may include a wireless power receiving unit receiving power in a wireless power transmission scheme, a battery being charged with the power received from the wireless power receiving unit, a monitoring unit monitoring a power state of the battery, a display unit displaying information on the power state of the battery from the monitoring unit on a screen, and a first wireless communications unit wirelessly transmitting the information on the power state of the battery from the monitoring unit together with tag identification information in a first wireless communications scheme.

### CROSS-REFERENCE TO RELATED APPLICATION

This application claims the benefit of Korean Patent Application No. 10-2013-0155686 filed on Dec. 13, 2013, with the Korean Intellectual Property Office, the disclosure of which is incorporated herein by reference.

### BACKGROUND

The present disclosure relates to an electronic tag, a system for wirelessly charging an electronic tag, an electronic shelf label system, and a method for managing power consumption by an electronic tag.

In general, an electronic shelf label system is provided to automatically manage merchandise item information and may include a plurality of electronic tags respectively provided for respective merchandise items, a gateway (GW) configuring a wireless network with the electronic tags to perform wireless communications, and a server performing wired communications with the gateway so as to control and manage the electronic tags via the gateway.

The electronic tag performs wireless communications with the server or with the gateway and electrically displays merchandise item information on a screen. To this end, the electronic tag has a battery provided therein.

Such batteries are required to be regularly replaced, and continual battery replacement may be disadvantageous in terms of time and cost.

### SUMMARY

An aspect of the present disclosure may provide an electronic tag, a system for charging an electronic tag, an electronic shelf label system, and a method for managing power of an electronic tag, in which the wireless charging of the electronic tag and the monitoring and controlling of the power of the electronic tag can be performed integrally.

According to an aspect of the present disclosure, an electronic tag may include: a wireless power receiving unit configured to receive power in a wireless power transmission scheme; a battery configured to be charged with the power received from the wireless power receiving unit; a monitoring unit configured to monitor a power state of the battery; a display unit configured to display information on the power state of the battery from the monitoring unit on a screen; and a first wireless communications unit configured to wirelessly transmit the information on the power state of the battery from the monitoring unit together with tag identification information in a first wireless communications scheme.

The wireless power transmission scheme may be a magnetic induction scheme or a magnetic resonance scheme.

The first wireless communications unit may transmit the information on the power state of the battery and the tag identification information to a management apparatus in the first wireless communications scheme.

The electronic tag may further include: a second wireless communications unit, if the information on the power state of the battery includes information on a low or empty charge state or a full charge state, configured to transmit a message indicating the information on a low or empty charge state or a full charge state to a terminal of a manager in a second wireless communications scheme.

According to another aspect of the present disclosure, a system for wirelessly charging an electronic tag may include: a wireless power transmitting device configured to transmit power in a wireless power transmission scheme; and an electronic tag configured to receive the power from the wireless power transmitting device in a wireless power transmission scheme so as to be charged and displaying merchandise item information on a screen, wherein the electronic tag includes: a wireless power receiving unit configured to receive power in a wireless power transmission scheme; a battery configured to be charged with the power received from the wireless power receiving unit; a monitoring unit configured to monitor a power state of the battery; a display unit configured to display information on the power state of the battery from the monitoring unit on a screen; and a first wireless communications unit configured to wirelessly transmit the information on the power state of the battery from the monitoring unit together with tag identification information in a first wireless communications scheme.

The wireless power transmitting device may include: a power management unit configured to supply power to be wirelessly transmitted; and a wireless power transmitting unit being electrically connected to the power management unit and being slidable along a tag holding rail so as to wirelessly transmit the power from the power management unit.

The wireless power transmitting unit may be electrically connected to the power management unit and may be slidable along the tag holding rail.

The wireless power transmitting device may include: a power management unit configured to supply power to be wirelessly transmitted; and first to N^{th} wireless power transmitting units being electrically connected to the power management unit and being fixedly disposed in different areas on tag holding rails so as to wirelessly transmit the power from the power management unit.

Each of the first to N^{th} wireless power transmitting units may include a magnetically-inductive transmitting coil part or a magnetically-resonant transmitting part.

The first to N^{th} wireless power transmitting units may be electrically connected to the power management in series or in parallel.

The first wireless communications unit may transmit the information on the power state of the battery to a management apparatus using wireless communications so that the information on the power state of the battery is transmitted to a terminal of a manager.

The electronic tag may further include: a second wireless communications unit, if the information on the power state of the battery includes information on a low or empty charge state or a full charge state, configured to transmit a message indicating the information on a low or empty charge state or a full charge state to a terminal of a manager in a second wireless communications scheme.

According to another aspect of the present disclosure, an electronic shelf label system may include: a wireless power transmitting device configured to transmit power in a wireless power transmission scheme; an electronic tag configured to receive the power from the wireless power transmitting device in a wireless power transmission scheme so as to be charged, display merchandise item information on a screen, and transmit detected information on a power state of the battery using wireless communications; and a management apparatus configured to receive the information on the power state of the battery from the electronic tag using wireless communications.

The electronic tag may include: a wireless power receiving unit configured to receive power in a wireless power transmission scheme; a battery configured to be charged with the power received from the wireless power receiving unit; a monitoring unit configured to monitor a power state of the battery; a display unit configured to display information on the power state of the battery from the monitoring unit on a screen; and a first wireless communications unit configured to wirelessly transmit the information on the power state of the battery from the monitoring unit together with tag identification information in a first wireless communications scheme.

The wireless power transmitting device may include: a power management unit configured to supply power to be wirelessly transmitted; and a wireless power transmitting unit configured to be electrically connected to the power management unit and be slidable along a tag holding rail so as to wirelessly transmit the power from the power management unit.

The wireless power transmitting unit may be electrically connected to the power management unit and may be slidable along the tag holding rail.

The wireless power transmitting device may include: a power management unit configured to supply power to be wirelessly transmitted; and first to N^{th} wireless power transmitting units being electrically connected to the power management unit and being disposed in different areas on tag holding rails so as to wirelessly transmit the power from the power management unit.

Each of the first to N^{th} wireless power transmitting units may include a magnetically-inductive transmitting coil part or a magnetically-resonant transmitting part.

The first to N^{th} wireless power transmitting units may be electrically connected to the power management in series or in parallel.

The first wireless communications unit may transmit the information on the power state of the battery to a management apparatus using wireless communications so that the information on the power state of the battery is transmitted to a terminal of a manager.

The electronic tag may further include: a second wireless communications unit, if the information on the power state of the battery includes information on a low or empty charge state or a full charge state, configured to transmit a message indicating the information on a low or empty charge state or a full charge state to a terminal of a manager in a second wireless communications scheme.

According to another aspect of the present disclosure, a method for managing power of an electronic tag may include: wirelessly receiving, by an electronic tag at a charge location on a tag holding rail, power from a wireless power transmitting device disposed at the charge location so that a battery in the electronic tag is charged; monitoring, by a monitoring unit in the electronic tag, a power state of the battery; and transmitting, by a first wireless communications unit in the electronic tag, to a management apparatus information on a power state of the battery from the monitoring unit in a first wireless communications scheme.

The method may further include: if the information on the power state of the battery includes information on a low or empty charge state or a full charge state, transmitting, by the electronic tag, a message indicating whether the information on the power state of the battery includes information on a low or empty charge state or a full charge state to a terminal of a manager in a second wireless communications scheme.

According to another aspect of the present disclosure, a method for managing power of an electronic tag in an electronic shelf label system may include: wirelessly receiving, by an electronic tag at a charge location on a tag holding rail, power from a wireless power transmitting device disposed at the charge location so that a battery in the electronic tag is charged; monitoring, by a monitoring unit in the electronic tag, a power state of a battery; transmitting, by a first wireless communications unit in the electronic tag, to a management apparatus information on the power state of the battery from the monitoring unit in a first wireless communications scheme; receiving, by the management apparatus, the information on the power state of the battery to store the information on the power state of the battery in association with the electronic tag; and transmitting, if the information on the power state of the battery includes information on a low or empty charge state or a full charge state, a message indicating it using wireless communications.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of an electronic tag according to an exemplary embodiment of the present disclosure;

FIG. 2 is a view showing the configuration of a system for wirelessly charging an electronic tag according to an exemplary embodiment of the present disclosure;

FIG. 3 is a view showing a wireless power transmitting device according to an exemplary embodiment of the present disclosure;

FIG. 4 is a view showing a wireless power transmitting device according to another exemplary embodiment of the present disclosure;

FIG. 5 is a view showing a wireless power transmitting device according to another exemplary embodiment of the present disclosure;

FIG. 6 is a block diagram of an electronic tag according to another exemplary embodiment of the present disclosure;

FIG. 7 is a view showing movement of the wireless power transmitting unit according to an exemplary embodiment of the present disclosure;

FIG. 8 is a block diagram of an electronic shelf label system according to an exemplary embodiment of the present disclosure;

FIG. 9 is a flowchart for illustrating a method for managing power of an electronic tag according to an exemplary embodiment of the present disclosure;

FIG. 10 is a flowchart for illustrating a method for managing power of an electronic tag according to another exemplary embodiment of the present disclosure; and

FIG. 11 is a flowchart for illustrating a method for managing power of an electronic shelf label system according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

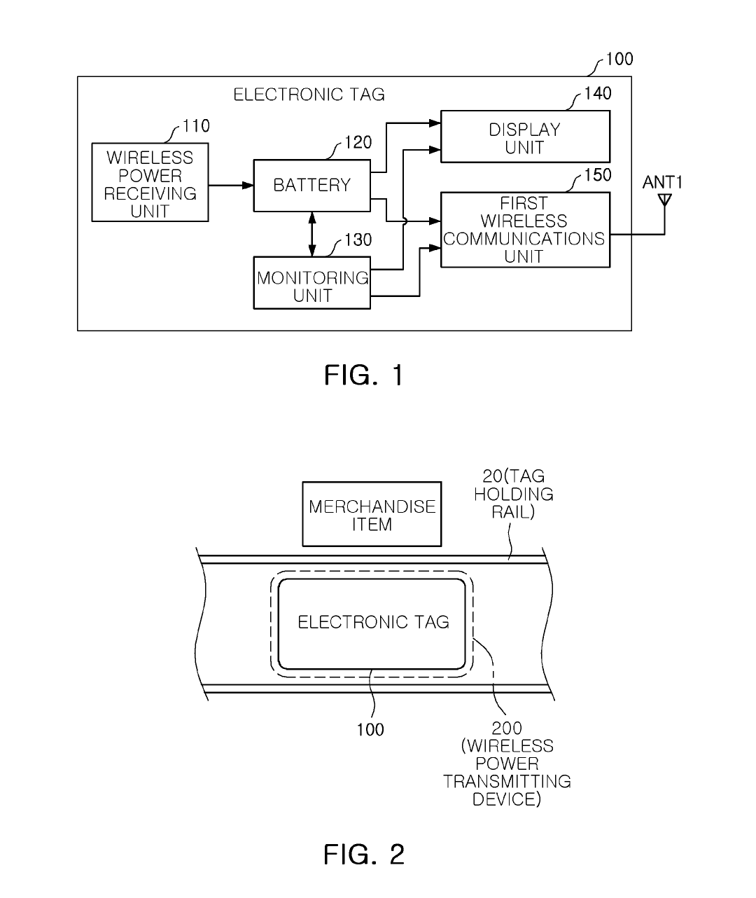

FIG. 1 is a block diagram of an electronic tag according to an exemplary embodiment of the present disclosure.

Referring to FIG. 1, the electronic tag according to the present disclosure may include a wireless power receiving unit 110, a battery 120, a monitoring unit 130, a display unit 140, and a first wireless communications unit 150.

FIG. 2 is a view showing the configuration of a system for wirelessly charging an electronic tag according to an exemplary embodiment of the present disclosure.

Referring to FIGS. 1 and 2, the system for wirelessly charging an electronic tag according to the exemplary embodiment may include a wireless power transmitting device 200 and an electronic tag 100.

As shown in FIG. 1, the electronic tag 100 may include the wireless power receiving unit 110, the battery 120, the monitoring unit 130, the display unit 140, and the first wireless communications unit 150.

The wireless power transmitting device 200 may sit inside a tag holding rail 20 and may transmit power in a wireless power transmission scheme.

The electronic tag 100 may be disposed on the tag holding rail 20, may receive power from the wireless power transmitting device 200 in a wireless transmission scheme to be charged, and may display merchandise item information on a screen using the charged power.

Referring to FIGS. 1 and 2, the wireless power receiving unit 110 in the electronic tag 100 may receive power from the wireless power transmitting device 200 in a wireless power transmission scheme.

Here, the wireless power transmission scheme may be a magnetic induction scheme or a magnetic resonance scheme.

The battery 120 may be charged with power received from the wireless power receiving unit 110. The battery 120 may be a rechargeable battery such as a secondary cell battery and may include, but is not limited to, a lithium ion battery, a lithium polymer battery or the like.

The monitoring unit 130 may monitor the power state of the battery 120 and may provide information on the power state of the battery. For example, the information on the power state of the battery may include information on the level of charged voltage, information on a low or empty charge state or a full charge state, and accordingly it can be determined whether the battery needs to be charged or is fully charged based on the information on the level of the voltage.

The display unit 140 may display on a screen the information on the power state of the battery 120 from the monitoring unit 130. The display unit 140 may display price information of a merchandise item or may display other information on merchandise items.

Further, the first wireless communications unit 150 may transmit the information on the power state of the battery 120 from the monitoring unit 130 along with tag identification information in a first wireless communications scheme. By utilizing the tag identification information, the power state of electronic tags can be managed individually.

Here, the first wireless communications scheme may be, but is not limited to, the ZigBee wireless communication protocol conforming to IEEE 802.15.4 standard.

The first wireless communications unit 150 may transmit the information on the power state of the battery 120 along with the tag identification information to a predetermined communication device. The predetermined communication device may be, but is not limited to, a gateway or server device that manages and controls merchandise item information and price information in the electronic tag or a terminal of a manager who manages a store where merchandise items are displayed.

The wireless power transmitting device 200 may employ a magnetic induction scheme or a magnetic resonance scheme.

Accordingly, the electronic tag 100 and the wireless power transmitting device 200 may employ the same wireless power transmission scheme.

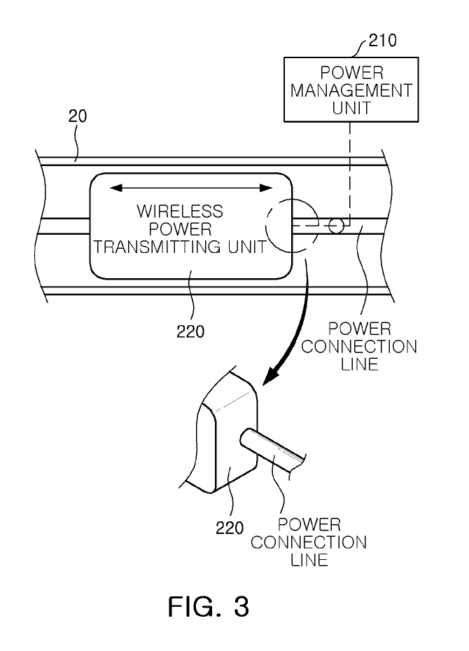

FIG. 3 is a view showing a wireless power transmitting device according to an exemplary embodiment of the present disclosure. The wireless power transmitting device 200 may include a power management unit 210 and a wireless power transmitting unit 220. The power management unit 210 may be a block capable of performing power conversion and control, and the wireless power transmitting unit 220 may be a block capable of transmitting power wirelessly. The two blocks may be implemented in two separate functional blocks or may be implemented in one functional block to perform the two functions described above.

Therefore, the technical idea of the present disclosure is not particularly limited to two functional blocks or one functional block as long as the wireless power transmitting device 200 includes the function of managing power and the function of transmitting power wirelessly.

The power management unit 210 may supply power to be transmitted wirelessly. The wireless power transmitting unit 220 may be electrically connected to the power management unit 210 and may sit inside the tag holding rail 20 so as to wirelessly transmit power from the power management unit 210. The wireless power transmitting unit 220 may be fixed to the tag holding rail 20 or may be slidable along the tag holding rail 20 so that it moves to a location where an electronic tag to be charged is disposed.

The power management unit 210 and the wireless power transmitting unit 220 may employ, but is not limited to, a magnetic induction scheme or a magnetic resonance scheme.

For example, if a magnetic resonance scheme is employed, the wireless power transmitting unit 220 may include a transmitting resonant part, and the wireless power transmitting frequency of the transmitting resonant part may be 6.78 MHz or 13.56 MHz conforming to the Alliance for Wireless Power (A4WP) standard.

Alternatively, the wireless power transmitting unit 220 may include a transmitting coil part that corresponds to a primary coil of a PWM controlled transformer. The wireless power transmitting frequency of the transmitting coil part may be 110 KHz or 282 KHz conforming to the wireless power consortium (WPC) standard, the power matters alliance (PMA) standard or the like.

For example, the wireless power transmitting unit 220 of the wireless power transmitting device 200 may be slidable along on the tag holding rail 20. A number of wireless power transmitting units 220 may be disposed in different areas on the tag holding rail 20, which are slidable along the tag holding rail 20.

As shown in FIG. 3, for example, a power connection line that is electrically connected to the power management unit 210 may be installed in the middle of the tag holding rail 20, and the wireless power transmitting unit 220 may sit inside the tag holding rail 20 so that it is slidable to the left and to the right, with being connected to the power connection line.

The structure in which the wireless power transmitting unit 220 slides is not particularly limited to a certain structure but may be variously implemented as long as the wireless power transmitting unit 220 is slidable along the tag holding rail 20 with being electrically connected to the power management unit 210.

As described above, it benefits to make the wireless power transmitting unit 220 slidable in that electronic tags can be charged with a fewer number of the wireless power transmitting units 220, compared to providing a wireless power transmitting unit 220 for every electronic tag.

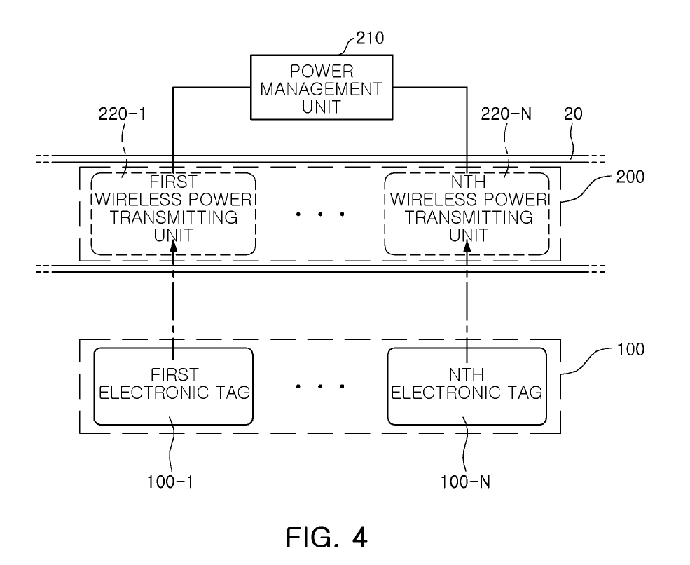

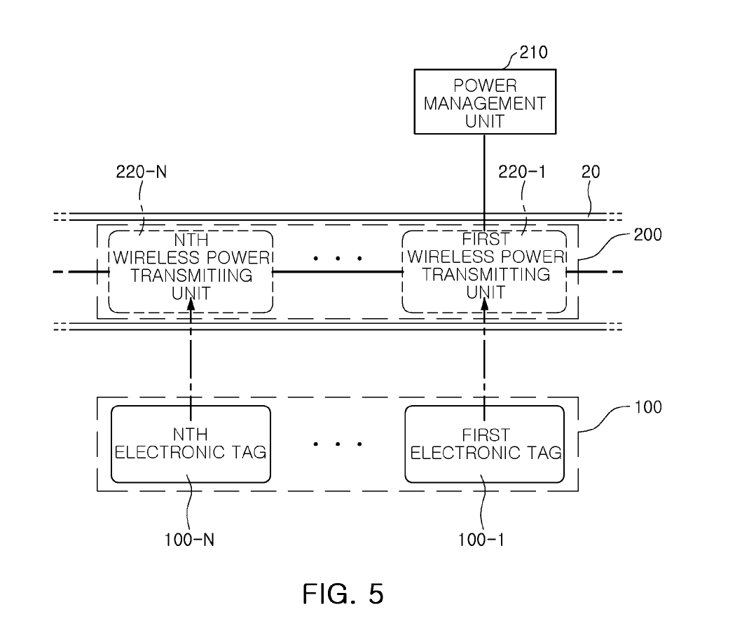

FIG. 4 is a view of a wireless power transmitting device according to another exemplary embodiment of the present disclosure, and FIG. 5 is a view of a wireless power transmitting device according to yet another exemplary embodiment of the present disclosure.

Referring to FIGS. 4 and 5, a wireless power transmitting unit 220 may include a power management unit 210 and first to N^{th} wireless power transmitting units 220-1 to 220-N.

The power management unit 210 may supply power to be transmitted wirelessly. Each of the first to N^{th} wireless power transmitting units 220-1 to 220-N may be connected to the power management unit 210 and may be fixed to a tag holding rail 20 in different areas thereon so as to transmit power from the power management unit 210 wirelessly.

As shown in FIG. 4, the power management unit 210 may be electrically connected to the first to N^{th} wireless power transmitting units 220-1 to 220-N in parallel. The first to N^{th} wireless power transmitting units 220-1 to 220-N may sit inside the tag holding rail 20, with one wireless power transmitting unit for each of first to N^{th} electronic tags 100-1 to 100-N.

Here again, the structure in which the first to N^{th} electronic tags 100-1 to 100N are disposed is not particularly limited to a certain structure but may be variously implemented as long as the wireless power transmitting units 220-1 to 220N sitting inside the tag holding rail 20 can wirelessly transmit power to the electronic tags, with being electrically connected to the power management unit 210. For example, the first to N^{th} electronic tags 100-1 to 100N may be fixed to or embedded in the tag holding rail 20.

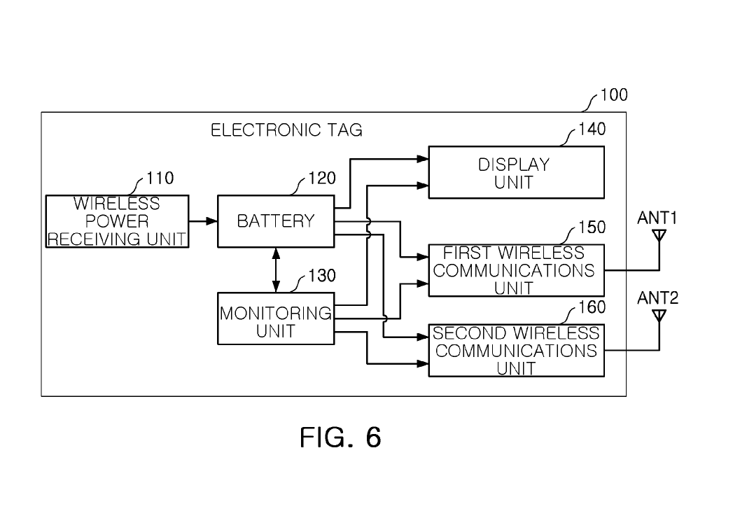

FIG. 6 is a block diagram of an electronic tag according to another exemplary embodiment of the present disclosure. Referring to FIG. 6, the electronic tag according to this exemplary embodiment may further include a second wireless communications unit 160 in addition to the elements in the electronic tag shown in FIG. 1.

In this exemplary embodiment, the information on a power state of the battery 120 may include various information items associated with the level of supply voltage, and, if the information on the power state of the battery 120 contains information on a low or empty charge state or a full charge state, the second wireless communications unit 160 may transmit a message indicating it to the terminal of a manager in a second wireless communications scheme.

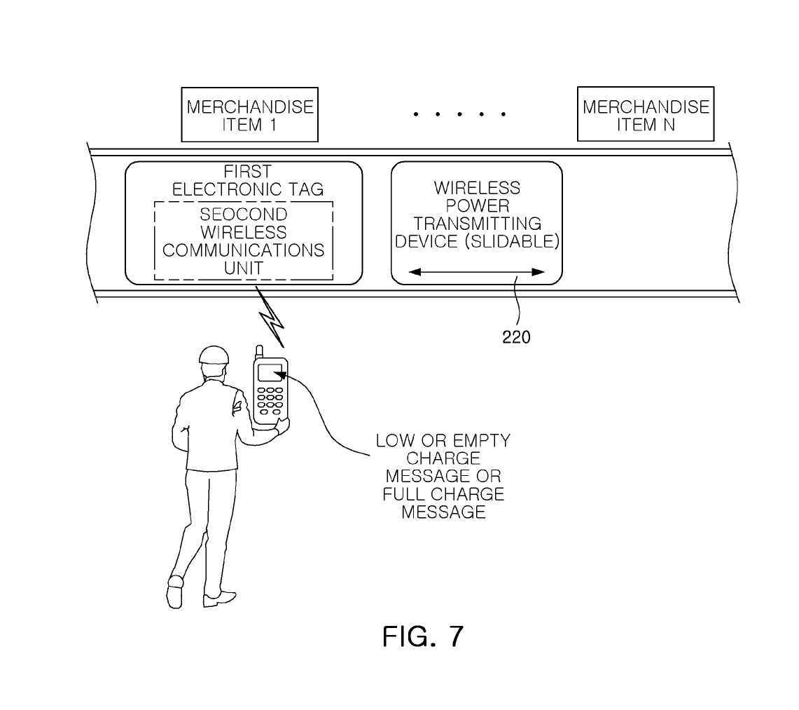

FIG. 7 is a view showing movement of the wireless power transmitting unit according to an exemplary embodiment of the present disclosure. Referring to FIGS. 3, 6 and 7, if the second wireless communications unit 160 transmits the information on the power state of the battery 120 including information on a low or empty charge state or a full charge state to the terminal of a manager, for example, the manager may check the information on a low or empty charge state or a full charge state using his terminal and may take an appropriate action depending on the information on the power state of the battery 120, such as moving the wireless power transmitting device to wirelessly charge an electronic tag or ending charging of an electronic tag.

The second wireless communications scheme may be the same as or different from the first wireless communications scheme.

For example, the second wireless communications scheme may be, but is not limited to, a personal area network (PAN) communication scheme according to Bluetooth® technology standardized as IEEE 802.15.1 or may be a local area network (LAN) communication scheme conforming to IEEE 802.15.11x standard (x represents a, b, g, n, ac or the like).

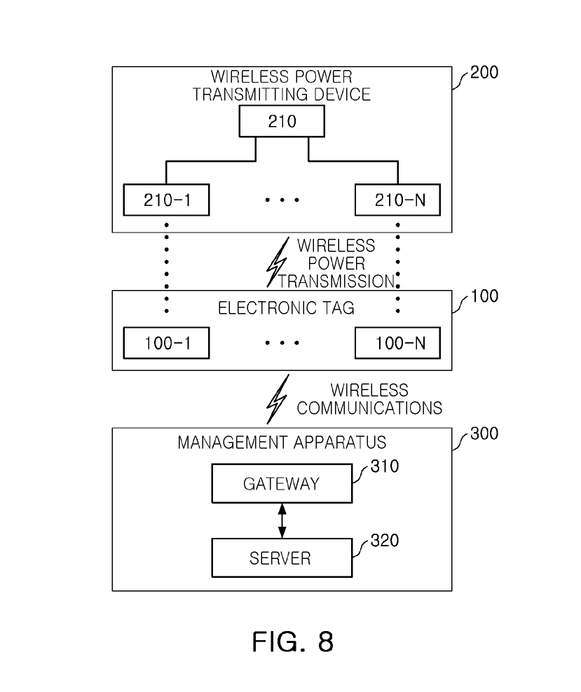

FIG. 8 is a block diagram of an electronic shelf label system according to an exemplary embodiment of the present disclosure.

Referring to FIG. 8, the electronic shelf label system according to the exemplary embodiment may include a wireless power transmitting device 200, electronic tags 100, and a management apparatus 300.

Among the wireless power transmitting device 200, the electronic tags 100, and the management apparatus 300, the same operations by the wireless power transmitting device 200 and the electronic tag 100 as those described above with respect to FIG. 1 may not be described again.

Referring to FIGS. 1 through 8, the wireless power transmitting device 200 may include a power management unit 210, and first to N^{th} wireless power transmitting units 220-1 to 220-N disposed in different areas on the tag holding rail 20.

The wireless power transmitting device 200 may transmit power in a wireless power transmission scheme.

The electronic tags 100 may include first to N^{th} electronic tags 110-1 to 100-N, each of which may be disposed in association with a respective one of first to N^{th} wireless power transmitting units 220-1 to 220-N.

The electronic tags 100 may receive power from the wireless power transmitting device 200 in a wireless power transmission scheme so as to be charged, may display merchandise item information on a screen, and may transmit detected information on a power state of the battery 120 using wireless communications.

Further, the management apparatus 300 may receive the information on the power state of the battery 120 from the electronic tags 100 using wireless communications. For example, the management apparatus 300 may include a gateway 310 and a server 320.

For example, the gateway 310 may receive wireless signals from the electronic tags 100 to transmit them to the server 320 and may wirelessly transmit a signal from the server 320 to the electronic tags 100. The server 320 may transmit merchandise item information to the electronic tags 100 via the gateway 310 and may receive, from the electronic tag 100, information on the state of the electronic tag 100 including information on the power state of the battery 120.

If the information on the power state of the battery 120 includes information on a low or empty charge state or a full charge state, the management apparatus 300 may transmit a message indicating it to the terminal of a manager using the first or second wireless communications scheme.

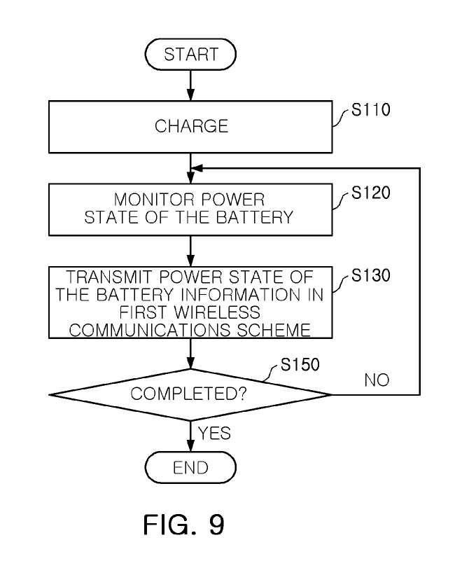

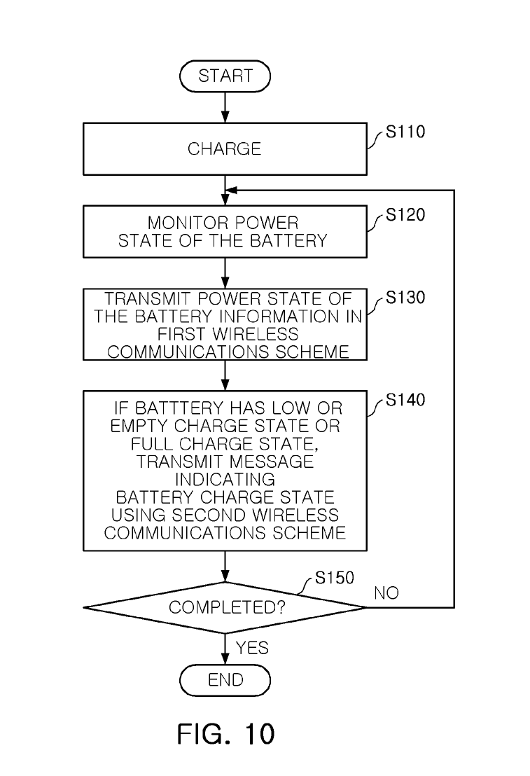

FIG. 9 is a flowchart for illustrating a method for managing power of an electronic tag according to an exemplary embodiment of the present disclosure, and FIG. 10 is a flowchart for illustrating a method for managing power of an electronic tag according to another exemplary embodiment of the present disclosure.

The methods for managing power of an electronic tag according to exemplary embodiments of the present disclosure will be described below with reference to FIGS. 1 through 10.

In the following descriptions on the methods for managing power of an electronic tag according to the exemplary embodiments of the present disclosure, the above descriptions with reference to FIGS. 1 to 8 may be equally applied, and thus the redundant descriptions will not be repeated.

Referring to FIGS. 1 through 9, an electronic tag 100 may be disposed at a charge location on a tag holding rail 20, and a wireless power receiving unit 110 in the electronic tag 100 may wirelessly receive power from a wireless power transmitting device 200 disposed at the charge location so as to charge a battery 120 in the electronic tag (S110).

Then, a monitoring unit 130 in the electronic tag 100 may monitor the power state of the battery 120 (S120).

Then, the first wireless communications unit 150 in the electronic tag 100 may transmit the information on the power state of the battery 120 from the monitoring unit 130 to a management apparatus 300 in a first wireless communications scheme (S130).

Referring to FIG. 10, if the information on the power state of the battery 120 includes information on a low or empty charge state or a full charge state, the electronic tag 100 may transmit a message indicating it to the terminal of a manager in a second wireless communications scheme (S140).

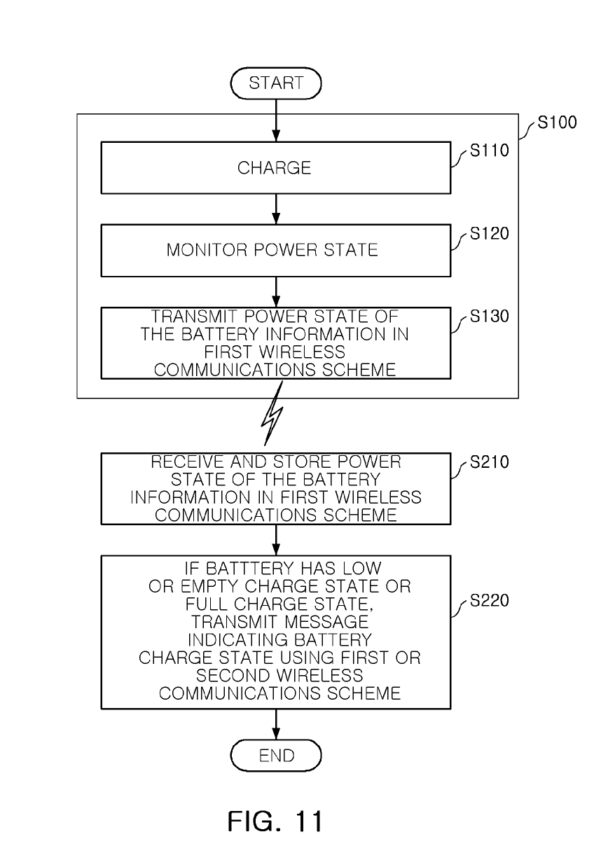

FIG. 11 is a flowchart for illustrating a method for managing power of an electronic shelf label system according to an exemplary embodiment of the present disclosure.

Referring to FIGS. 1 through 11, operations S110 through S130 in FIG. 11 may be performed in the same scheme as described above.

Then, the management apparatus 300 may receive information on the power state of the battery 120 to store it in association with an electronic tag 100 (S210).

Then, if the information on the power state of the battery 120 includes information on a low or empty charge state or a full charge state, the management apparatus 300 may transmit a message indicating it using wireless communications (S220).

As set forth above, according to exemplary embodiments of the present disclosure, in an electronic shelf label system including an electronic tag, the wireless charging of the electronic tag and the monitoring and controlling of the power of the electronic tag can be performed integrally.

While exemplary embodiments have been shown and described above, it will be apparent to those skilled in the art that modifications and variations could be made without departing from the spirit and scope of the present disclosure as defined by the appended claims.

What is claimed is:

1. An electronic tag, comprising:
a wireless power receiving unit configured to receive power in a wireless power transmission scheme;
a battery configured to be charged with the power received from the wireless power receiving unit;
a monitoring unit configured to monitor a power state of the battery;
a display unit configured to display information on the power state of the battery from the monitoring unit on a screen; and
a first wireless communications unit configured to wirelessly transmit the information on the power state of the battery from the monitoring unit together with tag identification information in a first wireless communications scheme.

2. The electronic tag of claim 1, wherein the first wireless communications unit is configured to transmit the information on the power state of the battery and the tag identification information to a management apparatus in the first wireless communications scheme.

3. The electronic tag of claim 1, further comprising: a second wireless communications unit, if the information on the power state of the battery includes information on a low or empty charge state or a full charge state, configured to transmit a message indicating the information on a low or empty charge state or a full charge state to a terminal of a manager in a second wireless communications scheme.

4. A system for wirelessly charging an electronic tag, comprising:
a wireless power configured to transmit device transmitting power in a wireless power transmission scheme; and
an electronic tag configured to receive the power from the wireless power transmitting device in a wireless power transmission scheme so as to be charged and displaying merchandise item information on a screen, wherein the electronic tag includes:
a wireless power receiving unit configured to receive power in a wireless power transmission scheme;
a battery configured to be charged with the power received from the wireless power receiving unit;
a monitoring unit configured to monitor a power state of the battery;
a display unit configured to display information on the power state of the battery from the monitoring unit on a screen; and
a first wireless communications unit configured to wirelessly transmit the information on the power state of the battery from the monitoring unit together with tag identification information in a first wireless communications scheme.

5. The system of claim 4, wherein the wireless power transmitting device includes:
a power management unit configured to supply power to be wirelessly transmitted; and
a wireless power transmitting unit configured to be electrically connected to the power management unit and be slidable along a tag holding rail so as to wirelessly transmit the power from the power management unit.

6. The system of claim 5, wherein the wireless power transmitting unit is electrically connected to the power management unit and is slidable along the tag holding rail.

7. The system of claim 4, wherein the wireless power transmitting device includes: a power management unit configured to supply power to be wirelessly transmitted; and first to N^{th} wireless power transmitting units configured to be electrically connected to the power management unit and be fixed to a tag holding rail in different regions so as to wirelessly transmit the power from the power management unit.

8. The system of claim 4, wherein the first wireless communications unit transmits the information on the power state of the battery to a management apparatus using wireless communications so that the information on the power state of the battery is transmitted to a terminal of a manager.

9. The system of claim 4, wherein the electronic tag further includes: a second wireless communications unit, if the information on the power state of the battery includes information on a low or empty charge state or a full charge state, configured to transmit a message indicating the information on a low or empty charge state or a full charge state to a terminal of a manager in a second wireless communications scheme.

10. An electronic shelf label system, comprising:
a wireless power transmitting device configured to transmit power in a wireless power transmission scheme;
an electronic tag configured to receive the power from the wireless power transmitting device in a wireless power transmission scheme so as to be charged, display merchandise item information on a screen, and transmit detected information on a power state of the battery using wireless communications; and
a management apparatus configured to receive the information on the power state of the battery from the electronic tag using wireless communications.

11. The electronic shelf label system of claim 10, wherein the electronic tag includes:
a wireless power receiving unit configured to receive power in a wireless power transmission scheme;
a battery configured to be charged with the power received from the wireless power receiving unit;
a monitoring unit configured to monitor a power state of the battery;
a display unit configured to display information on the power state of the battery from the monitoring unit on a screen; and
a first wireless communications unit configured to wirelessly transmit the information on the power state of the battery from the monitoring unit together with tag identification information in a first wireless communications scheme.

12. The electronic shelf label system of claim 10, wherein the wireless power transmitting device includes:
a power management unit configured to supply power to be wirelessly transmitted; and
a wireless power transmitting unit configured to be electrically connected to the power management unit and be slidable along a tag holding rail so as to wirelessly transmit the power from the power management unit.

13. The electronic shelf label system of claim 12, wherein the wireless power transmitting unit is electrically connected to the power management unit and is slidable along the tag holding rail.

14. The electronic shelf label system of claim 10, wherein the wireless power transmitting device includes:
a power management unit configured to supply power to be wirelessly transmitted; and
first to N^{th} wireless power transmitting units being electrically connected to the power management unit and being disposed in different areas on tag holding rail so as to wirelessly transmit the power from the power management unit.

15. The electronic shelf label system of claim 11, wherein the first wireless communications unit transmits the information on the power state of the battery to a management apparatus using wireless communications so that the information on the power state of the battery is transmitted to a terminal of a manager.

16. The electronic shelf label system of claim 10, wherein the tag further includes: a second wireless communications unit, if the information on the power state of the battery includes information on a low or empty charge state or a full charge state, configured to transmit a message indicating the information on a low or empty charge state or a full charge state to a terminal of a manager in a second wireless communications scheme.

17. A method for managing power of an electronic tag, comprising:
wirelessly receiving, by an electronic tag at a charge location on a tag holding rail, power from a wireless power transmitting device disposed at the charge location so that a battery in the electronic tag is charged;
monitoring, by a monitoring unit in the electronic tag, a power state of the battery; and
transmitting, by a first wireless communications unit in the electronic tag, to a management apparatus information on a power state of the battery from the monitoring unit in a first wireless communications scheme.

18. The method of claim 17, further comprising: if the information on the power state of the battery includes information on a low or empty charge state or a full charge state, transmitting, by the electronic tag, a message indicating whether the information on the power state of the battery includes information on a low or empty charge state or a full charge state to a terminal of a manager in a second wireless communications scheme.

19. A method for managing power of an electronic tag in an electronic shelf label system, the method comprising:
wirelessly receiving, by an electronic tag at a charge location on a tag holding rail, power from a wireless power transmitting device disposed at the charge location so that a battery in the electronic tag is charged;
monitoring, by a monitoring unit in the electronic tag, a power state of a battery;
transmitting, by a first wireless communications unit in the electronic tag, to a management apparatus information on the power state of the battery from the monitoring unit in a first wireless communications scheme;
receiving, by the management apparatus, the information on the power state of the battery to store the information on the power state of the battery in association with the electronic tag; and
transmitting, if the information on the power state of the battery includes information on a low or empty charge state or a full charge state, a message indicating it using wireless communications.
